(19) United States
(12) Patent Application Publication
(10) Pub. No.: US 2014/0158804 A1
(43) Pub. Date: Jun. 12, 2014

(54) PRETENSIONER OF SEAT BELT FOR VEHICLE

(71) Applicant: HYUNDAI MOTOR COMPANY, Seoul (KR)

(72) Inventor: Hyun Woo Lee, Ansan (KR)

(73) Assignee: HYUNDAI MOTOR COMPANY, Seoul (KR)

(21) Appl. No.: 13/840,783

(22) Filed: Mar. 15, 2013

(30) Foreign Application Priority Data
Dec. 12, 2012 (KR) 10-2012-0144962

(51) Int. Cl. B60R 22/46

(52) U.S. Cl. CPC B60R 22/4633
USPC 242/374

(57) ABSTRACT

Disclosed herein is a pretensioner of a vehicle seat belt. The elements of the pretensioner required to rotate a spool are disposed within the spool. Furthermore, the pretensioner includes a spool around which the seat belt is wound, wherein the spool includes an internal space open on an end of the spool. A cylinder is installed in the internal space and is extractable from the internal space. Additionally, the pretensioner includes a gas generator that is installed in a first end of the cylinder to connect the gas generator to the cylinder and a spool actuating module that is configured to connect the spool to the cylinder, and rotate the spool using gas pressure generated from the gas generator.

### CROSS-REFERENCE TO RELATED APPLICATION

This application claims under 35 U.S.C. §119(a) the benefit of Korean Patent Application No. 10-2012-0144962 filed on Dec. 12, 2012 the entire contents of which are incorporated herein by reference.

### BACKGROUND OF THE INVENTION

1. Field of the Invention

The present invention relates generally to pretensioners of vehicle seat belts and, more particularly, to a pretensioner of a vehicle seat belt in which elements required to rotate a spool are disposed in the spool.

2. Description of the Related Art

Conventional seat belt pretensioners are classified into a steel ball type pretensioner and a rack type pretensioner. As shown in FIG. 1, in the steel ball type pretensioner, when a gas generator 1 is operated, steel balls 3 are moved along a passageway 4 and discharged out of an installation space by pressure of gas 2 generated by the operation of the gas generator 1. Furthermore, a ring gear 5 and a pinion 6 are rotated together (e.g., in a direction designated by arrow R1) by movement of the steel balls 3. When the pinion 6 rotates, a spool 7 which is connected to the pinion 6 is rotated. When the spool 7 rotates, the seat belt is wound around the spool 7, thus fixing the upper body of a passenger.

However, in the conventional steel ball type pretensioner, the elements (e.g., the gas passage, the steel balls, the ring gear, etc.) which operate the spool 7 using pressure of the gas 2 are disposed outside the spool 7. As a result, the size of the pretensioner increasing, thus reducing space efficiency in of the product. Therefore, it may be difficult to install the pretensioner in a rear seat. Particularly, the structure of the steel ball type pretensioner is complex including a substantial amount parts, thus increasing the weight and the manufacturing cost of the pretensioner.

Moreover, as shown in FIG. 2, in the rack type pretensioner, a rack 12 is moved along a guide 13 by gas pressure generated from the gas generator 11. When the pinion 14 rotates, the spool 15 rotates together with the pinion 14. When the spool 15 rotates, the seat belt 16 is wound around the spool 15, thus fixing the upper body of a passenger.

However, in the same manner as the ball type pretensioner, in the rack type pretensioner the various elements (e.g., the gas passage, the rack, etc.) required to rotate the spool 15 are disposed outside the spool 15, thus increasing the size of the pretensioner and reducing the space efficiency. Therefore, it may be difficult to install the rack type pretensioner in a rear seat. The structure of the rack type pretensioner is also complex including a substantial amount of parts, thus increasing the weight and the manufacturing cost of the pretensioner.

It is to be understood that the foregoing description is provided to merely aid the understanding of the present invention, and does not mean that the present invention falls under the purview of the related art which was already known to those skilled in the art.

### SUMMARY

Accordingly, the present invention provides a pretensioner of a vehicle seat belt, wherein the elements required to rotate a spool are disposed within the spool, thus simplifying the construction of the pretensioner, and reducing the size of the pretensioner, thereby enhancing space efficiency allowing the pretensioner to be installed in a rear seat, and thus reducing the weight and production cost.

The present invention provides a pretensioner of a vehicle seat belt, including: a spool around which the seat belt is wound, the spool having an internal space open on an end of the spool; a cylinder installed in the internal space so as to be extractable from the internal space; a gas generator installed in a first end of the cylinder to directly connect the gas generator to the cylinder; and a spool actuating module configured to connect the spool to the cylinder, the spool actuating module rotating the spool using gas pressure generated from the gas generator.

The pretensioner may further include a cylinder locking module disposed both on the cylinder and on a frame disposed adjacent to the first end of the cylinder, wherein the cylinder locking module may be configured to restrict the rotation of the cylinder to allow the spool to be smoothly rotated when the spool actuating module is operated.

The cylinder may include: a disc part abutting (e.g., in contact with) the open end of the spool; a cylindrical part protruding from a first surface of the disc part, wherein the cylindrical part may be installed in the internal space of the spool to be movable along the internal space; and an installation part protruding from a second surface of the disc part, wherein the installation part may be disposed through the frame to be rotatable relative to the frame, wherein the gas generator may be installed in the installation part.

The spool actuating module may include: a spool guide groove spirally formed in an inner surface of the internal space of the spool in a longitudinal direction of the internal space; a cylinder guide slot linearly formed in the cylindrical part in a longitudinal direction of the cylindrical part, wherein the cylinder guide slot may be connected to the installation part and may be open on an outer surface of the cylindrical part; and a piston installed both in the spool guide groove and in the cylinder guide slot, wherein the piston may be moved by the gas pressure generated from the gas generator along the spool guide groove and the cylinder guide slot, whereby the spool may be rotated.

The cylinder locking module may include: a locking protrusion having a hook shape and protruding from the disc part of the cylinder in a direction substantially similar to a direction in which the installation part protrudes from the disc part; and a locking depression formed in a surface of the frame that faces the disc part, wherein when the disc part is moved to the frame by the gas pressure generated from the gas generator, the locking protrusion may be inserted into and hooked to the locking depression. The disc part of the cylinder may seal the internal space of the spool until the gas generator is operated.

### BRIEF DESCRIPTION OF THE DRAWINGS

The above and other objects, features and advantages of the present invention will be more clearly understood from the following detailed description taken in conjunction with the accompanying drawings, in which:

FIGS. 1 and 2 are exemplary views respectively illustrating a conventional steel ball type pretensioner and a conventional rack type pretensioner according to the related art;

FIGS. 3 and 4 are exemplary views illustrating the state of a pretensioner of a vehicle seat belt when a gas generator is not operated, according to an exemplary embodiment of the present invention;

FIG. 5 is an exemplary view illustrating a spool according to an exemplary embodiment of the present invention;

FIGS. 6 and 7 are exemplary views illustrating a piston according to an exemplary embodiment of the present invention; and

FIG. 8 is an exemplary view illustrating the state of the pretensioner when the gas generator is operated, according to an exemplary embodiment of the present invention.

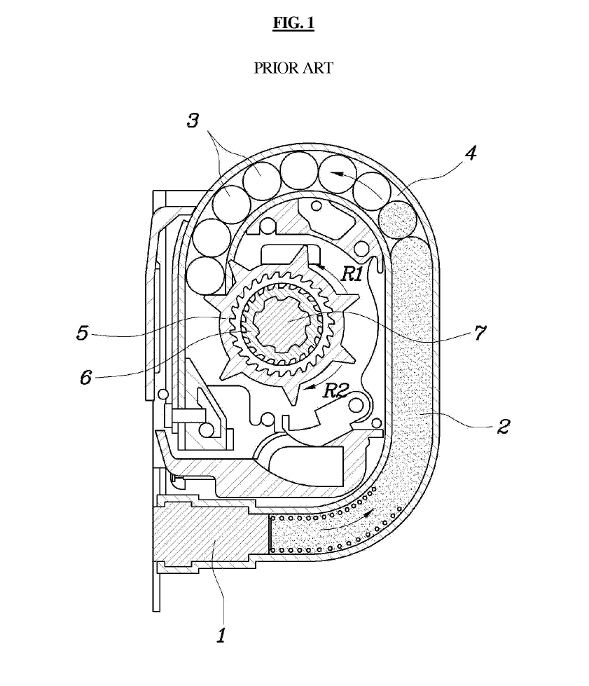

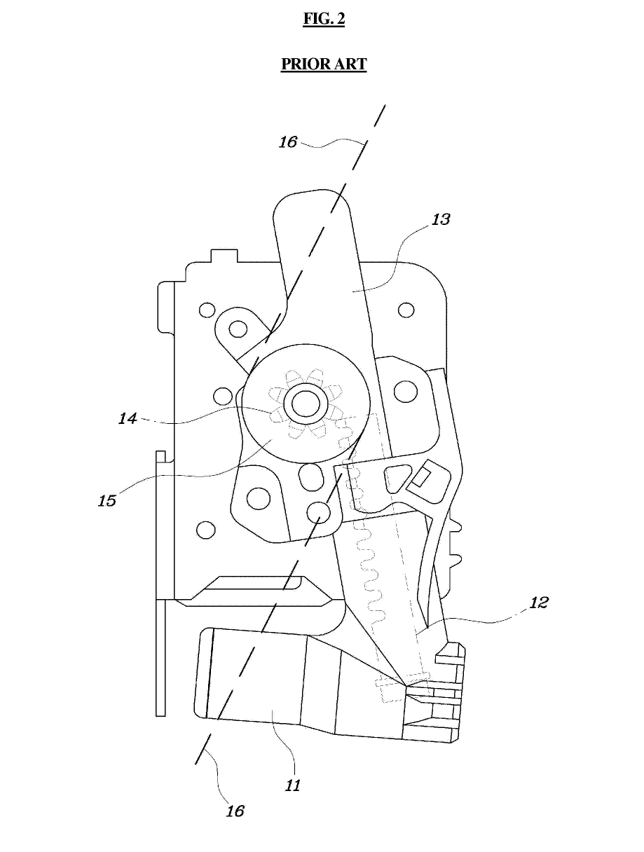

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Hereinafter, a pretensioner of a vehicle seat belt according to an exemplary embodiment of the present invention will be described in detail with reference to the accompanying drawings.

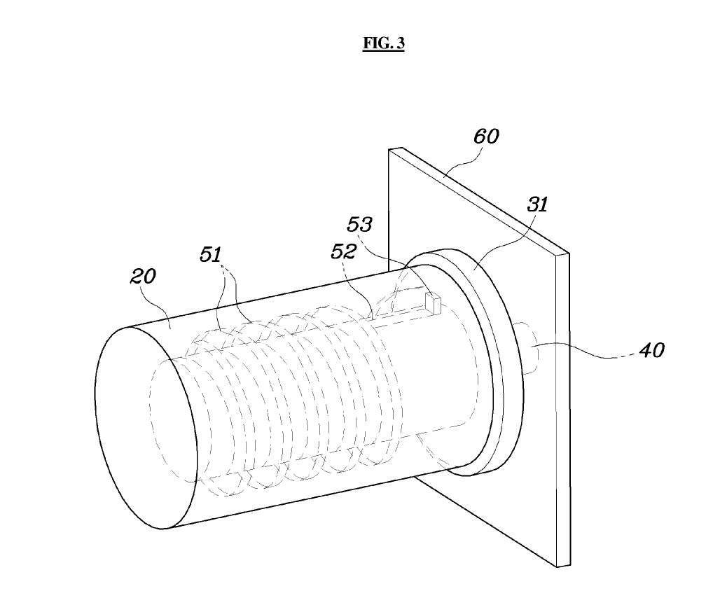

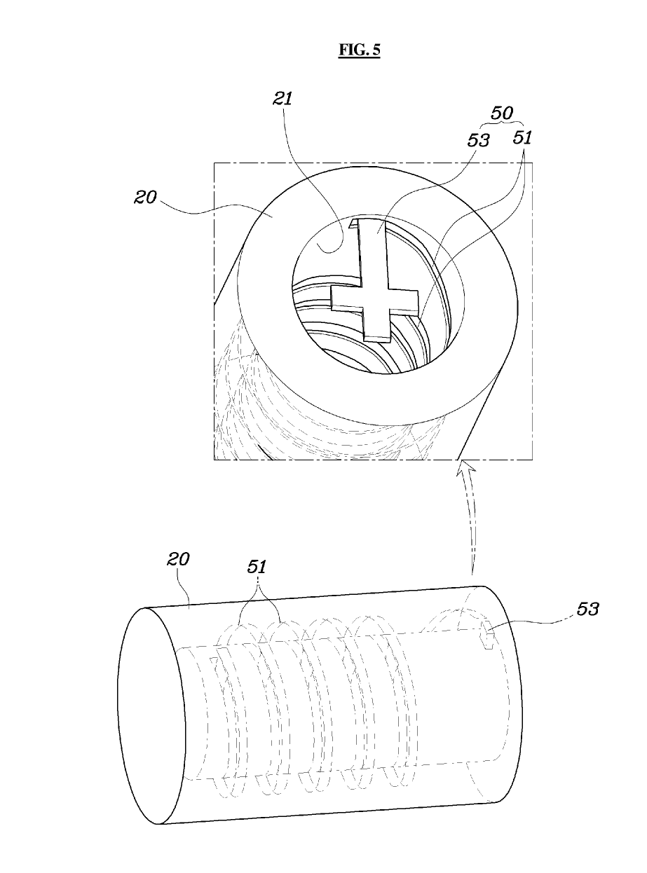

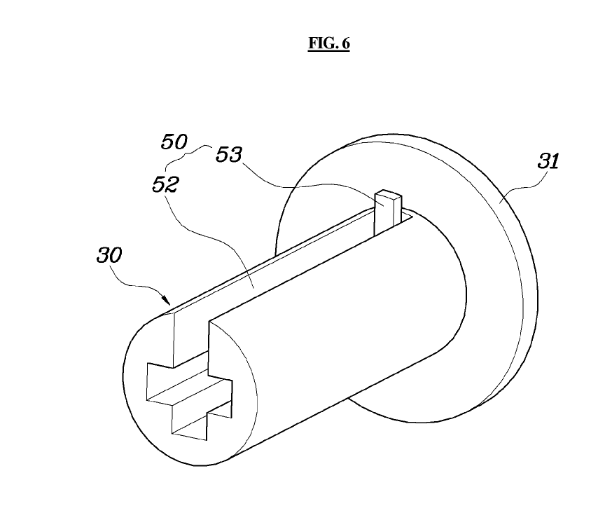

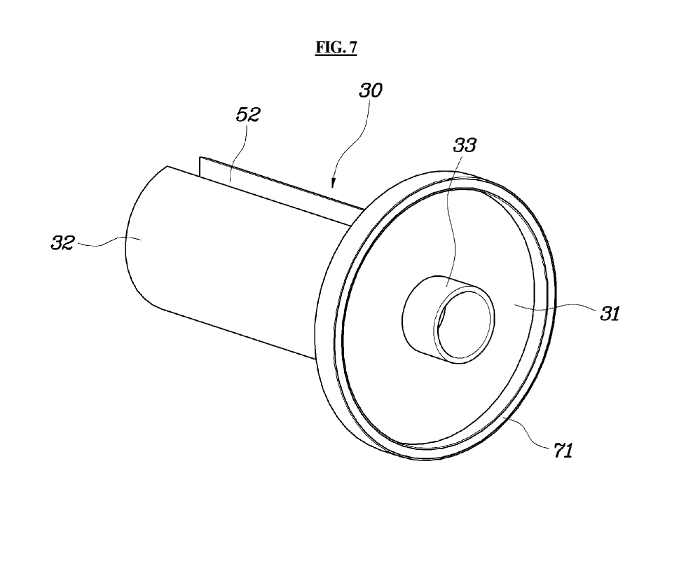

As shown in FIGS. 3 through 8, the pretensioner according to the present invention may include a spool 20, a cylinder 30, a gas generator 40, a spool actuating module 50 and a cylinder locking module 70. The seat belt may be wound around the spool 20. The spool 20 may have an internal space 21 open on one end of the spool 20. The cylinder 30 may be installed in the internal space 21 to be extractable from the internal space 21. The gas generator 40 may be installed in a first end of the cylinder 30 to connect the gas generator 40 to the cylinder 30. The spool actuating module 50 may be configured to connect the spool 20 to the cylinder 30. The spool actuating module 50 may be configured to rotate the spool 20 using the gas pressure generated from the gas generator 40. The cylinder locking module 70 may be disposed both on the cylinder 30 and on a frame 60 which may be disposed adjacent to the first end of the cylinder 30. When the spool actuating module 50 is operated, the cylinder locking module 70 may be configured to restrict rotation of the cylinder 30 to allow the spool 20 to be substantially smoothly rotated. The gas generator 40 may be directly coupled to the first end of the cylinder 30 to reduce the size of the pretensioner.

The cylinder 30 may include a disc part 31, a cylindrical part 32 and an installation part 33. The disc part 31 may abut (e.g., be in contact with) the open end of the spool 20. The cylindrical part 32 may protrude from a first surface of the disc part 31 and may be installed in the internal space 21 of the spool 20 to be movable along the internal space 21. The installation part 33 may protrude from a second surface of the disc part 31 and may be disposed through the frame 60 to be rotatable relative to the frame 60. The gas generator 40 may be installed in the installation part 33.

The spool actuating module 50 may include a spool guide groove 51, a cylinder guide slot 52 and a piston 53. The spool guide groove 51 may be formed in an inner surface of the internal space 21 of the spool 20 in a spiral shape along the longitudinal direction of the internal space 21. The cylinder guide slot 52 may be linearly formed in the cylindrical part 32 in the longitudinal direction of the cylindrical part 32. The cylinder guide slot 52 may be connected to the installation part 33 and open on the outer surface of the cylindrical part 32. The piston 53 may be installed both in the spool guide groove 51 and in the cylinder guide slot 52. The piston 53 may be moved by the gas pressure generated from the gas generator 40 along the spool guide groove 51 and the cylinder guide slot 52. The spool 20 may be rotated by the movement of the piston 53.

Although the cylinder guide slot 52 and the piston 53 have been illustrated as forming a cross shape to enhance contact force between the cylinder 30 and the piston 53, the present invention is not limited to this.

The cylinder locking module 70 may include a locking protrusion 71 having a hook shape and protruding from the disc part 31 of the cylinder 30 in substantially the same direction as that of the installation part 33, and a locking depression 72 which may be formed in a surface of the frame 60 that faces the disc part 31. When the disc part 31 is moved to the frame 60 by the gas pressure generated from the gas generator 40, the locking protrusion 71 may be inserted into and hooked to the locking depression 72.

The locking protrusion 71 and the locking depression 72 may be configured to restrict the cylinder 30 from being rotated by the gas pressure of the gas generator 40. Additionally, the disc part 31 may be configured to seal the internal space 21 of the spool 20 until the gas generator 40 is operated.

In other words, when the gas generator 40 is not operated, the internal space 21 of the spool 20 may be sealed. Thus, at an initial stage of the operation of the gas generator 40, gas may be prevented from being discharged from the spool 20. Thus, initial actuating force of the piston 53 may be increased. As a result, the rotating force of the spool 20 may be increased.

The operation of the present invention will be described below.

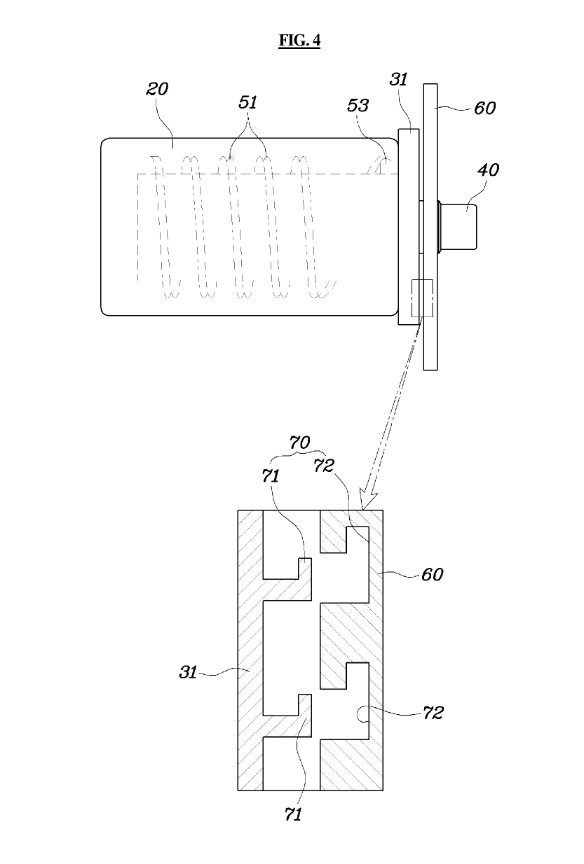

FIGS. 3 and 4 show the state of the pretensioner before the vehicle is involved in an accident, in other words, when the gas generator 40 is not operated. In particular, the spool 20 may be configured to substantially smoothly rotate along with the cylinder 30 and the piston 53 relative to the frame 60, thus operating as a retractor which, using elastic force of a spring, may be configured to retract the seat belt that has been unwound.

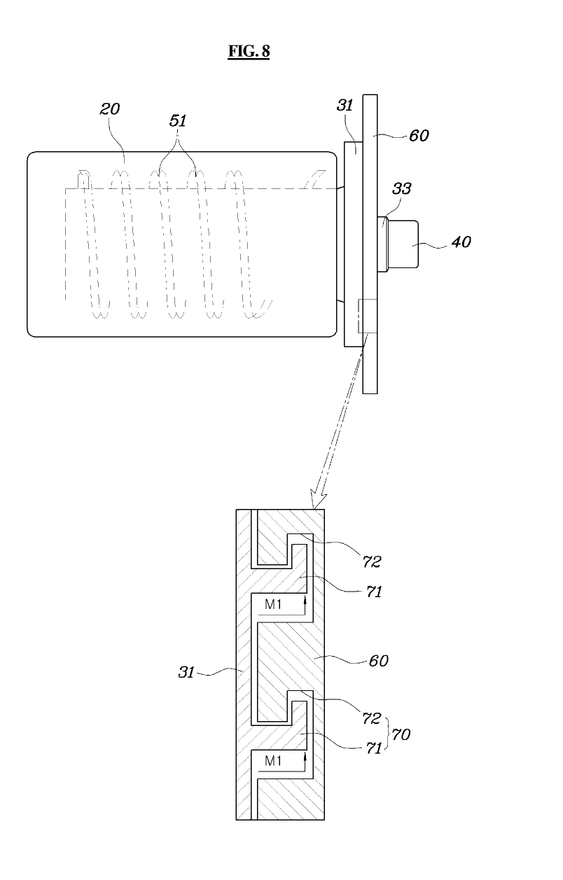

FIG. 8 illustrates the state of the pretensioner when the vehicle is involved in an accident and the gas generator 40 is operated. When a vehicle accident occurs, the gas generator 40 may be operated by a control signal from a controller to generate gas. The gas may apply pressure to the piston 53 to move the piston 53. A lower part of the piston 53 may linearly move along the cylinder guide slot 52, while an upper part of the piston may simultaneously move along the spiral spool guide groove 51 that is formed in the spool 20.

When the piston 53 moves, the spool 20 may be rotated in one direction by the moving force of the piston 53 that is moving along the spiral spool guide groove 51. Furthermore, the seat belt may be wound around the spool 20, thus fixing the upper body of the passenger. As such, the spool 20 may operate as a pretensioner.

Moreover, when gas is generated by the operation of the gas generator 40, the cylinder 30 may move to the frame 60 by the gas pressure until the disc part 31 contacts (e.g., abuts) with the frame 60. The locking protrusion 71 which protrudes from the disc part 31 may be moved in the direction of arrow M1 and inserted into the locking depression 72 formed in the frame 60. Therefore, the rotation of cylinder 30 may be restricted by the locking protrusion 71 and the locking depression 72. Thus, the force of the spool 20 rotation to retract the seat belt may increase.

Further, the cylindrical part 32 of the cylinder 30 may be removed from the internal space 21 of the spool 20 by the gas pressure and moved towards the frame 60. Then, the cylinder guide slot 52 formed in the cylindrical part 32 may communicate with the exterior of the device to allow gas generated from the gas generator 40 to be discharged out of the spool 20 through the cylinder guide slot 52 that communicates with the exterior.

As described above, in the embodiment of the present invention after the gas generator 40 is operated, gas may be discharged out of the spool 20 through the cylinder guide slot 52. Thus, the present invention may prevent an overshoot phenomenon, in which reverse rotation of the spool 20 is impeded by residual gas pressure when a load limitation function is performed. Therefore, the present invention may prevent an initial load of the seat belt from increasing when the load limitation function is performed, thus enhancing the performance of protecting the passenger.

Furthermore, the gas generator 40 may be integrally coupled to the first end of the cylinder 30. Particularly, the elements of the spool 20 which may include the cylinder 30, the spool guide groove 51, the cylinder guide slot 52, the piston 53, etc. which are operated by the gas pressure may be integrally disposed within the spool 20. Therefore, compared to the conventional steel ball type pretensioner or the conventional rack type pretensioner, the size of the present invention may be reduced, thus decreasing the required installation space. Moreover, the present invention may be installed in a rear seat which exhibits limited space.

Moreover, unlike the conventional technique, the present invention may use, to rotate the spool 20, the cylinder 30 and the piston 53 which are disposed within the spool 20, without requiring a steel ball or a rack Therefore, the present invention may reduce the number of parts, thus reducing the manufacturing cost and the weight of the pretensioner.

Although the exemplary embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. A pretensioner of a vehicle seat belt, comprising:
a spool around which the seat belt is wound, wherein the spool includes an internal space open on an end of the spool;
a cylinder installed in the internal space to be extractable from the internal space;
a gas generator installed in a first end of the cylinder to connect the gas generator to the cylinder; and
a spool actuating module configured to connect the spool to the cylinder, and rotate the spool using gas pressure generated from the gas generator.

2. The pretensioner as set forth in claim 1, further comprising a cylinder locking module disposed both on the cylinder and on a frame disposed adjacent to the first end of the cylinder, wherein the cylinder locking module may be configured to restrict rotation of the cylinder to allow the spool to be rotated when the spool actuating module is operated.

3. The pretensioner as set forth in claim 2, wherein the cylinder includes:
a disc part in contact with the open end of the spool;
a cylindrical part protruding from a first surface of the disc part, and installed in the internal space of the spool to be movable along the internal space; and
an installation part protruding from a second surface of the disc part, and disposed through the frame to be rotatable relative to the frame, wherein the gas generator is installed in the installation part.

4. The pretensioner as set forth in claim 3, wherein the spool actuating module includes:
a spool guide groove spirally formed in an inner surface of the internal space of the spool in a longitudinal direction of the internal space;
a cylinder guide slot linearly formed in the cylindrical part in a longitudinal direction of the cylindrical part, wherein the cylinder guide is connected to the installation part and open on an outer surface of the cylindrical part; and
a piston installed both in the spool guide groove and in the cylinder guide slot, and configured to move by gas the pressure generated from the gas generator along the spool guide groove and the cylinder guide slot, to rotate the spool.

5. The pretensioner as set forth in claim 3, wherein the cylinder locking module includes:
a locking protrusion having a hook shape and protruding from the disc part of the cylinder in a direction substantially similar to a direction in which the installation part protrudes from the disc part; and
a locking depression formed in a surface of the frame that faces the disc part, wherein when the disc part is moved toward the frame by the gas pressure generated from the gas generator, the locking protrusion is inserted into and hooked to the locking depression.

6. The pretensioner as set forth in claim 5, wherein the disc part of the cylinder is configured to seal the internal space of the spool until the gas generator is operated.
